(19) United States
(12) Patent Application Publication
(10) Pub. No.: US 2007/0215746 A1
(43) Pub. Date: Sep. 20, 2007

(54) Aircraft Having A Ring-Shaped Wing Structure

(76) Inventors: William D. Rieken, Nara (JP); Joerg Benscheidt, Bonn (DE)

Correspondence Address: KODA & ANDROLIA, 2029 CENTURY PARK EAST, SUITE 1140, LOS ANGELES, CA, 90067, US

(21) Appl. No.: 10/594,979

(22) PCT Filed: Sep. 21, 2004
(86) PCT No.: PCT/JP04/14121

§ 371 Date: Nov. 3, 2006

(30) Foreign Application Priority Data
Mar. 29, 2004 (JP) 2004-094745

(51) Int. Cl. B64C 39/06

(52) U.S. Cl. 244/6; 244/34 A; 244/45 R; 244/51; 244/52; 244/55

(57) ABSTRACT

The aircraft includes a boomerang-shaped front wing (4), curving gibbously to the front, having a leading edge (4F), a trailing edge (4B) and the first and second airfoil tips (4E1, 4E2), a boomerang-shaped rear wing (6), curving gibbously to the back, having a leading edge (6F), a trailing edge (6B) and the third and forth airfoil tips 86E1, 6E2), the first wing box (8L) connecting the first airfoil tip of the front wing and the third airfoil tip of the rear wing, the second wing box (8R) connecting the second airfoil tip of the front wing and the fourth airfoil tip of the rear wing. The trailing edge of the front wing, the leading edge of the rear wing, and the internal surfaces of the wing boxes form a center opening (9) having, at least in part, elliptical shape.

### BACKGROUND OF THE INVENTION

1. Field of the Invention

This present invention generally relates to aircraft, especially to aircraft having a boomerang shape wing structure (hereinafter, in this specification, the word “boomerang shape” includes both round type of boomerang and straight-line type of boomerang).

2. Description of the Related Art

There are some cases in which it is difficult to approach afflicted areas of large-scale disasters such as huge earthquakes because of severed transit systems. Consequently, unmanned aircraft with surveillance cameras collecting information from the sky, to survey for victims and afflicted areas, are currently being researched.

However, an unmanned helicopter risks setting off a secondary disaster. For example, when it tries to approach afflicted areas more closely by descending for a more detailed investigation, taking advantage of its mobility, there is a risk that its large blades will collide with the wall of a building.

U.S. Pat. No. 5,520,355 discloses an aircraft, called the GEOBAT, whose periphery is circular and which includes a front wing, a rear wing and a pair of wing tips which connect the front wing and the rear wing, forming basically a three-wing structure with a circular center opening.

However, the GEOBAT, which has an all-circular wing structure, has the disadvantage that it has a considerably smaller opening in the center relative to the aircraft size, therefore it provides not much space for components to be mounted there.

### SUMMARY OF THE INVENTION

It is, therefore, an objective of the present invention to provide an aircraft which is able to fly and maneuver safely in places like inhabitable areas that are dangerous for helicopters to fly and maneuver in.

To achieve the above objective, the aircraft of the present invention in one embodiment includes a boomerang-shaped front wing, curving gibbously to the front, which has a leading edge, a trailing edge and the first and second airfoil tips, a boomerang-shaped rear wing, curving gibbously to the back, which has a leading edge, a trailing edge and the third and forth airfoil tips, the first wing box (a streamlined body) connecting the first airfoil tip of the front wing and the third airfoil tip of the rear wing, the second wing box connecting the second airfoil tip of the front wing and the fourth airfoil tip of the rear wing. The trailing edge of the front wing, the leading edge of the rear wing, the internal surface of the first wing box and the internal surface of the second wing box form a center opening having, at least in part, a substantially elliptical shape (including a perfect circle as one embodiment). Thus, this invention is basically a circular, elliptic, or rhombus-shaped two-wing planform with two wings of similar or identical size, as compared to the circular three-wing planform with differently sized and differently configured wings of the aforementioned GEOBAT.

According to an embodiment of the present invention, since the propellers are arranged in the center opening so as to prevent them from colliding with the wall of a building, the aircraft can fly and maneuver safely even in areas that are dangerous for conventional aircraft, helicopters, and airships to fly and maneuver in.

In this specification and claims, words indicating direction such as “front”, “rear”, “back”, “up”, “down”, “top”, “bottom”, “horizontal” and so forth are based on the position of the aircraft flying level and straight.

### BRIEF DESCRIPTION OF THE DRAWINGS

FIG. 1 is a perspective view of an aircraft according to an embodiment of the present invention;

FIG. 2 is a front view of the aircraft shown in FIG. 1;

FIG. 3 is a top view of the aircraft shown in FIG. 1;

FIG. 4 is a bottom view of the aircraft shown in FIG. 1;

FIG. 5 is a rear view of the aircraft shown in FIG. 1;

FIG. 6 is a side view of the aircraft shown in FIG. 1;

FIG. 7 is a perspective view showing the engines of the aircraft shown in FIG. 1 rotated into a vertical position;

FIG. 8 is a perspective view of an aircraft according to another embodiment of the present invention (a different positioning of the vertical fins);

FIG. 9 is a perspective view of an aircraft according to a further embodiment of the present invention (without vertical fins and with drag rudders);

FIG. 10 is a perspective view of an aircraft according to another embodiment of the present invention (a glider version without a central body);

FIG. 11 is a perspective view of an aircraft according to another embodiment of the present invention (a glider version with pylon);

FIG. 12 is a perspective view of an aircraft according to a further embodiment of the present invention (a motorized version without a central body);

FIG. 13 is a top view of an aircraft according to further embodiment of the present invention (a polygonal wing edge version);

FIG. 14 is a top view of an aircraft according to another embodiment of the present invention (rhombus-shaped jet engine version);

FIG. 15 is a top view of an aircraft according to further embodiment of the present invention (jet version with circular wings);

FIG. 16a, FIG. 16b and FIG. 16c show side views of an aircraft according to an embodiment of the present invention showing variations of the inclination (angle of incidence) of the two wings;

FIG. 17 is a top view showing the peripheral shape of the center opening of the aircraft in FIG. 1 formed by part of two perfect circles;

FIG. 18 shows top views of an aircraft showing examples of the peripheral shape of the center opening with a wide aspect ratio relative to the wing span direction;

FIG. 19 is a top view showing the positions of the center of gravity of the aircraft shown in FIG. 1;

FIG. 20 is a top view showing that the wings with circular-elliptical wing structure have a continuously changing angle between the wing edge and the airflow;

FIG. 21 is a top view of an aircraft according to another embodiment of the present invention (pusher propeller version);

FIG. 22 is a perspective view of an aircraft according to another embodiment of the present invention (helicopter version);

FIG. 23 is a top view of the aircraft shown in FIG. 22.

### DESCRIPTION OF THE PREFERRED EMBODIMENTS

Referring to the figures, the following description will discuss embodiments of the present invention. In the following description, only unmanned aircraft are described as the embodiments of the present invention; however, the present invention can be also applied to manned aircraft.

In addition, the aircraft of the present invention can be used in various kinds of fields other than being used for gathering information at a time of disaster. For example, they can be used for the purposes of security or monitoring from the sky, for scientific and atmosphering sensing, as a sensor platform, or for recreation or transportation.

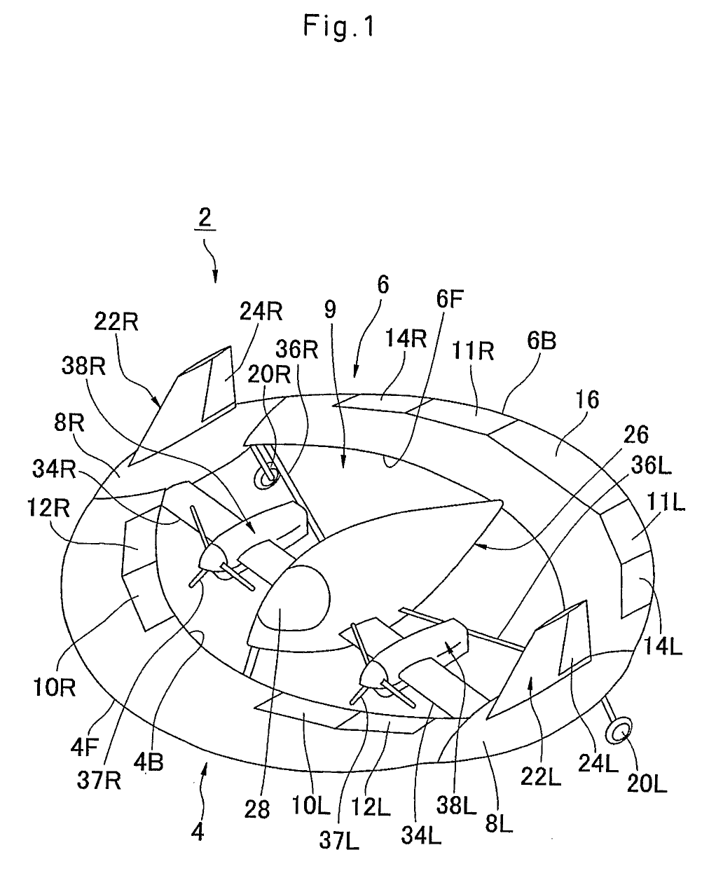

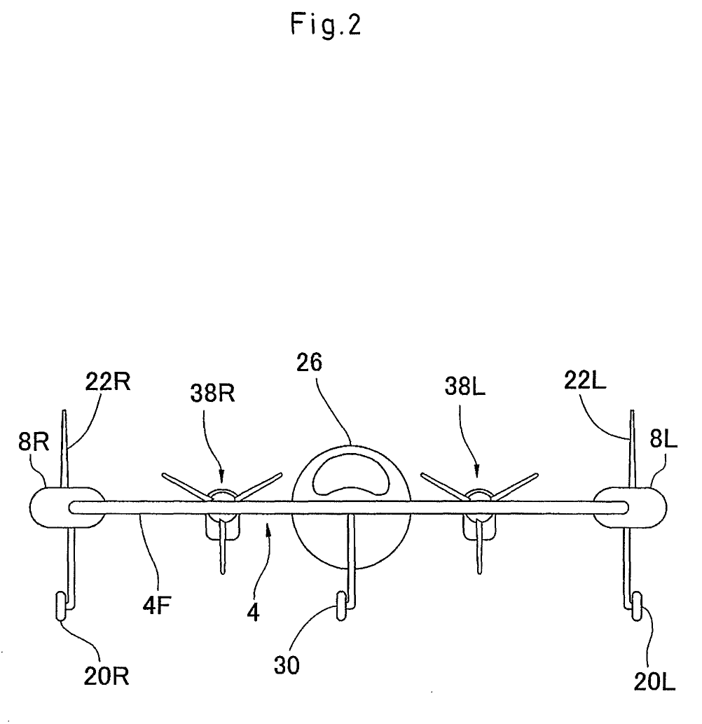

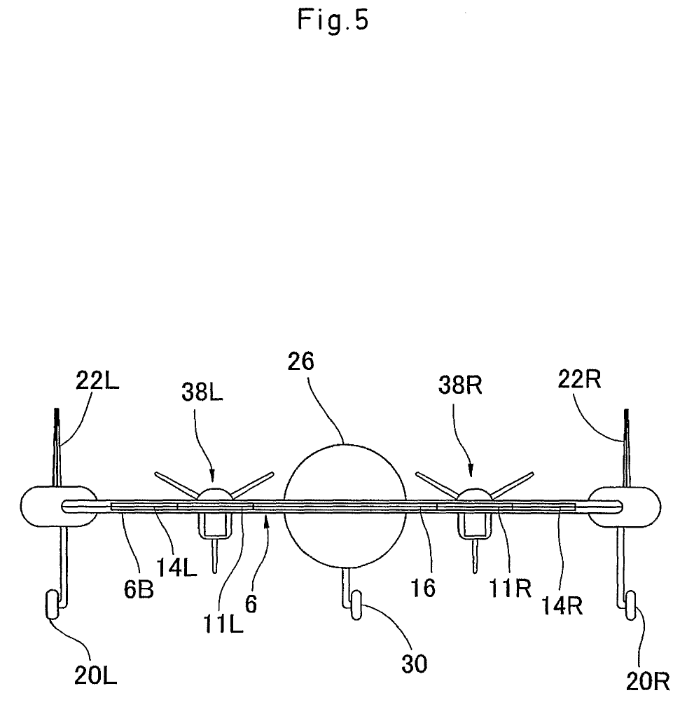

FIGS. 1 to 6 show an aircraft according to one embodiment of the present invention. The aircraft 2 includes a front wing 4, a rear wing 6, both having an almost identical boomerang shape as the main wings, and a pair of wing boxes 8L and 8R, having an aerodynamic shape, which connect the front wing 4 and the rear wing 6 at airfoil tips. The aircraft 2 has a line-symmetric shape with reference to a center line extending along the horizontal direction (which is the normal direction of flight), and the center line is hereinafter referred to as the “standard line”. When the aircraft 2 is viewed from the rear as shown in FIG. 5, the term “left (L)” is used for components located to the left of the standard line and the term “right (R)” is used for components located to the right of the standard line.

(Airfoil Section)

The front wing 4 includes a semi-circular leading edge 4F, a semi-circular trailing edge 4B, an airfoil tip (the first airfoil tip) 4E₁ connected to the wing box 8L and an airfoil tip (the second airfoil tip) 4E₂ connected to the wing box 8R. The front wing 4 has a boomerang shape with a convex curvature from the middle of the aircraft 2 to the front. On the other hand, the rear wing 6 includes a semi-circular leading edge 6F, a semi-circular trailing edge 6B, an airfoil tip (the third airfoil tip) 6E₁ connected to the wing box 8L and an airfoil tip (the forth airfoil tip) 6E₂ connected to the wing box 8R. The rear wing 6 has a boomerang shape with a convex curvature from the middle of the aircraft 2 to the back (in the opposite direction to the front wing 4). The airfoil of the front wing 4 and the rear wing 6 have a designated wing thickness and shape. As one example, the airfoil type NACA2412 can be used for the front wing 4 and the rear wing 6. As another example, the front and rear wings may use different airfoils (e.g. NACA2412 and A6020).

(Shape of the Wing Edges)

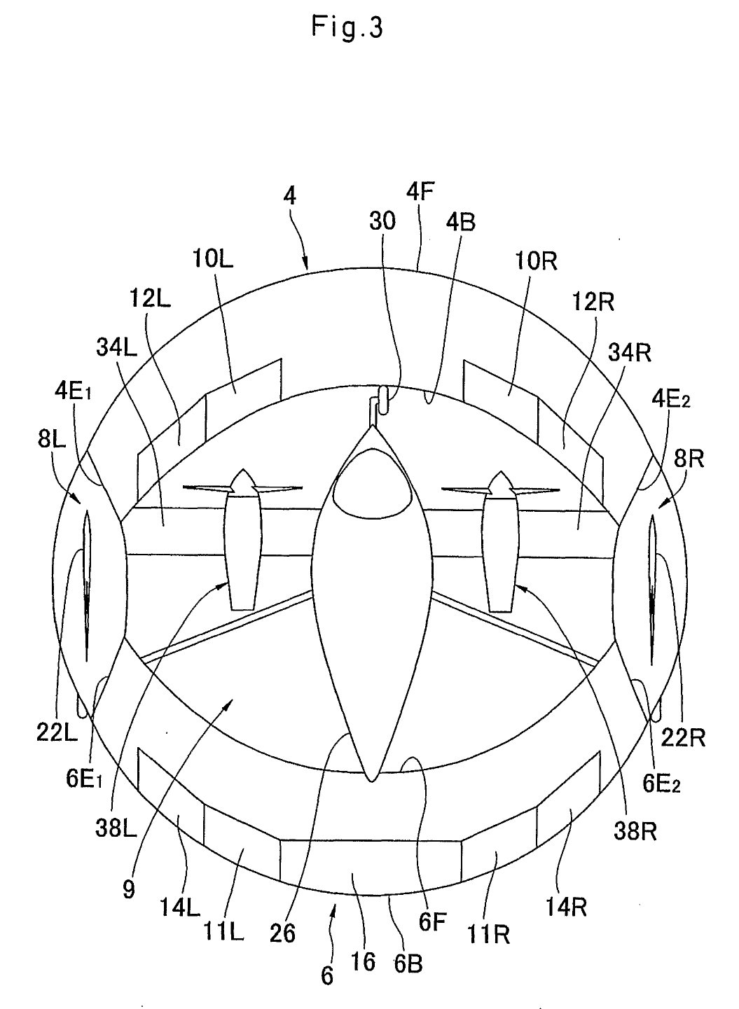

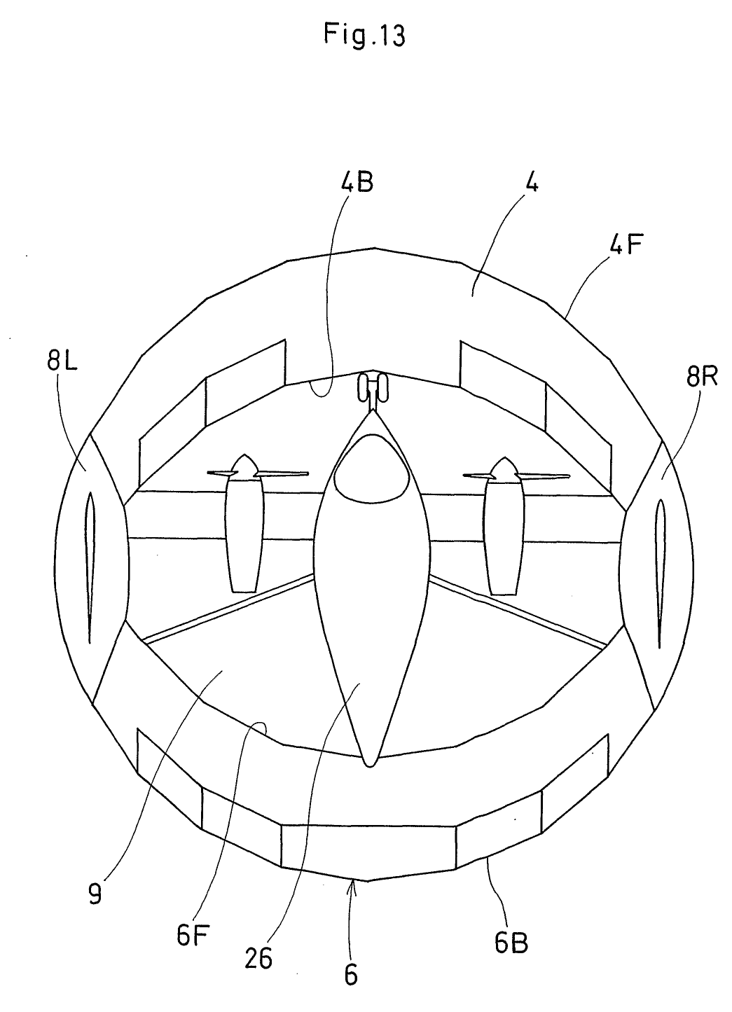

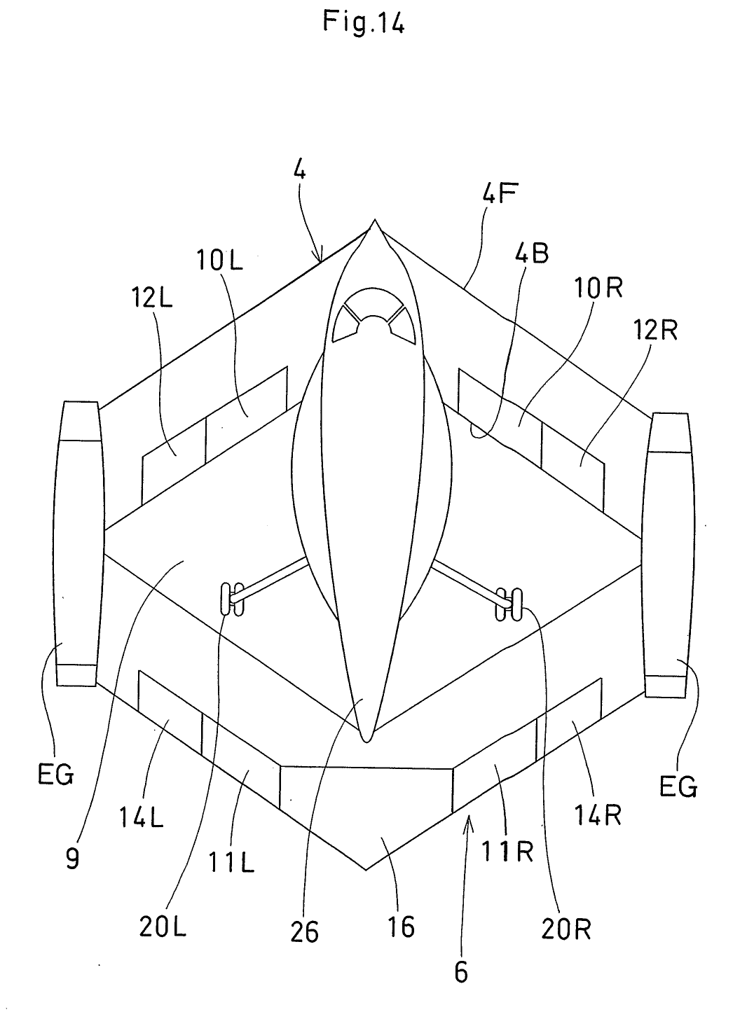

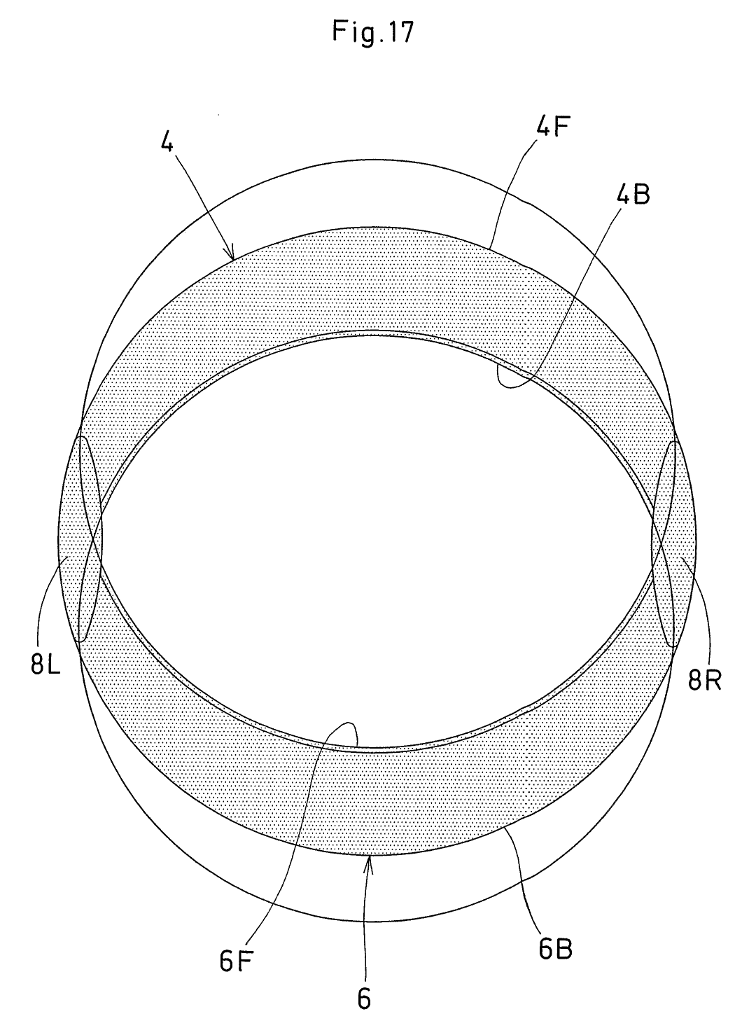

The wing edges 4F, 4B, 6F and 6B can have any shapes as long as the wings 4 and 6 basically have a boomerang shape. For example, the wing edges may have a circular arc (semi-circular) shape, an elliptical arc (semi-elliptical) shape, semi-polygonal shape as shown in FIG. 13, or a V-shape as shown in FIG. 14. In the first embodiment as shown in FIG. 3, a center opening 9 is formed by the trailing edge 4B of the front wing 4, the leading edge 6F of the rear wing 6 and inner surfaces of the wing boxes 8L and 8R. A planar outline of the aircraft 2 is formed by the leading edge 4F of the front wing 4, the trailing edge 6B of the rear wing 6 and lateral surfaces of the wing boxes 8L and 8R. The planar outline of the aircraft 2, as shown in FIG. 3, has a perfect circular shape in a plane view with part of the semi-circular leading edge 4F of the front wing 4 and part of the semi-circular trailing edge 6B of the rear wing 6. The center opening 9 has a roughly elliptical shape in a plane view with part of the semi-circular trailing edge 4B of the front wing 4 and part of the semi-circular leading edge 6F of the rear wing 6. In this embodiment shown in FIG. 3, the trailing edge 4B of the front wing 4 and the leading edge 6F of the rear wing 6 are actually circular arcs, however, the centers of the two circles defining them are offset as shown in FIG. 17, so the resulting shape of the center opening is roughly elliptical. The center of the perfect circular planar outline and the foci of the roughly elliptical center opening 9 are located on the same lines, either the line extending from the center to the front and rear direction or the line extending from the center to the wingspan direction.

In the above embodiment, the aircraft 2 is designed so that the leading edge 4F of the front wing 4 and the trailing edge 6B of the rear wing 6 have a semi-circular shape, the trailing edge 4B of the front wing 4 and the leading edge 6F of the rear wing 6 form a roughly elliptical shape of the center opening, and the center of the semi-circular edges and the foci of the roughly elliptical opening are located on the same position relative to the front and rear direction. However, the shape of the wing edges 4F, 4B, 6F and 6B is not limited thereto as long as the space of the center opening 9 becomes large enough for large components (such as a cabin) to be mounted there. For example, the aircraft 2 may be designed so that the leading edge 4F of the front wing 4 and the trailing edge 6B of the rear wing 6 have a semi-elliptical shape or the center of the semi-circular edges and the foci of the semi-elliptical edges are located at different positions relative to the front and rear direction.

(The Shape of the Center Opening)

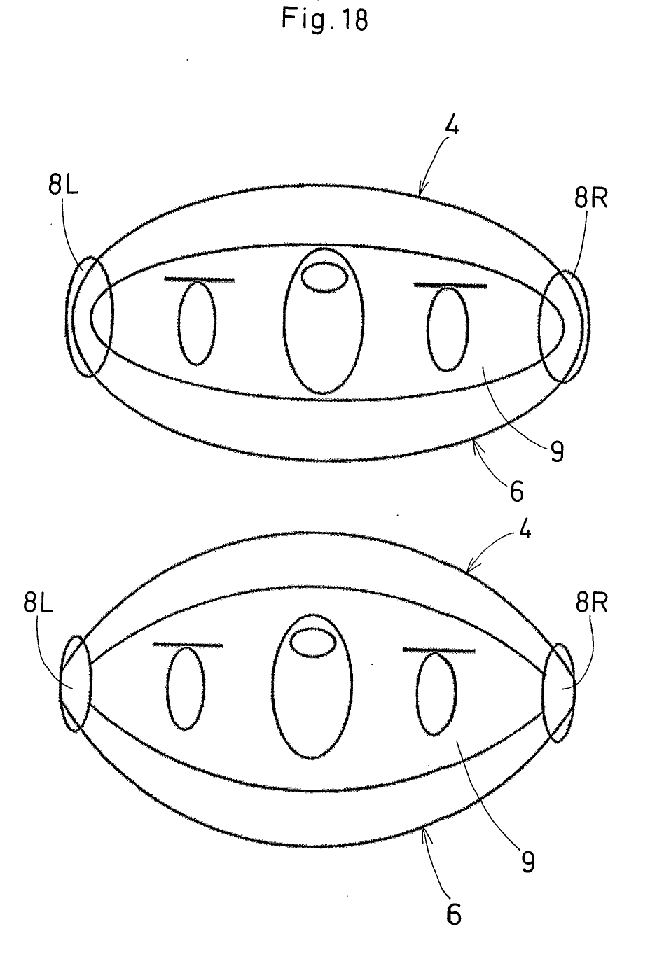

The peripheral shape of the center opening 9 does not have to be mathematically elliptical as shown in FIG. 3 and FIG. 17. As other embodiments of this invention, the peripheral shape of the center openings 9 can be formed to be of polygonal shape, as shown in FIG. 13, or substantially rhombus-shaped with two V-shaped wing edges, as shown in FIG. 14, having the longer axis extending to the wingspan direction. Moreover, the peripheral shape of the center openings 9, as shown in FIG. 17, can be formed by part of two perfect circles. The peripheral shape of the center opening 9 may be also formed by the combination of semi-elliptical edges whose foci are located at different positions and whose diameters are different lengths. Alternatively, the peripheral shape may be formed by connecting any points on the semi-elliptical edges combined with straight lines. However, in either case, it is preferred for safety reasons that the center opening 9 has a symmetrical shape relative to the standard line. FIG. 18 shows examples of the peripheral shape of the center opening 9 with a wide aspect ratio relative to the wing span direction.

(Chord Length)

In most of the embodiments described above, the radial width of the front wing 4 and the rear wing 6 gets shorter from the middle toward the wing boxes 8L and 8R and therefore the space of the center opening 9 can be large enough for equipment to be mounted there. This is different from the aforementioned GEOBAT which has an all-circular wing structure with a considerably smaller opening in the center relative to the aircraft size.

The chord lengths of the front wing 4 and the rear wing 6 do not have to be identical as shown in the figures, but can be reduced or increased in length for either of the two wings, changing the wing area accordingly. Thus the ratio between the lifting force of the front wing 4 and the rear wing 6 can be changed, which is useful, for example, to achieve a certain desired position for the center of gravity (see below).

(Inclination of Chord Lines)

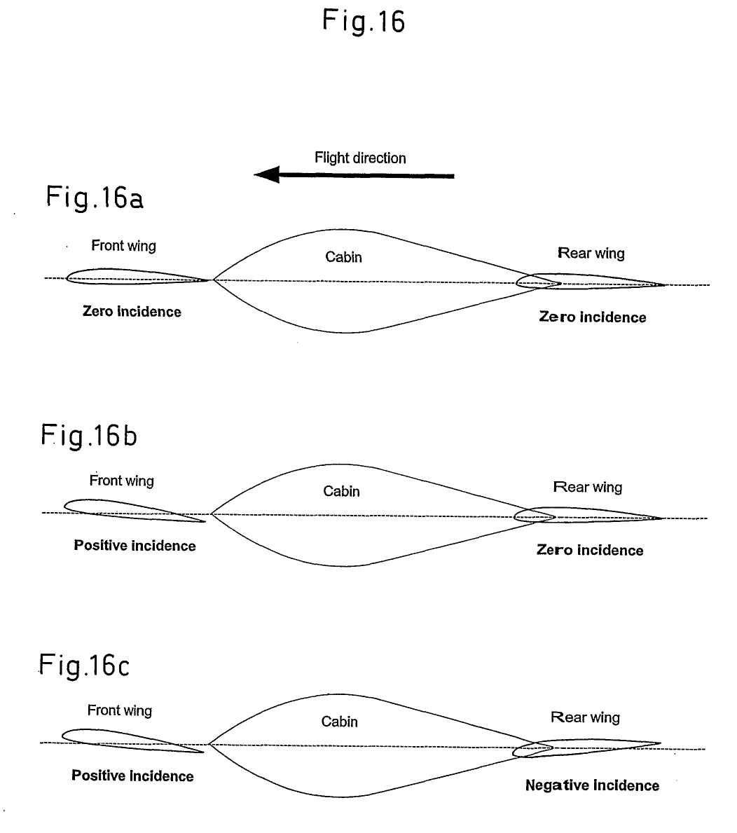

In an embodiment of this invention, the chord lines of the front wing 4 are parallel the horizontal surface which is substantially orthogonal to the up and down direction, which means that the angle of incidence (angle against the airflow) of the front wing 4 is zero (see FIG. 16a). Apart of or all of the chord lines of the rear wing 6 are slightly inclined relative to the chord lines of the front wing 4 so that the leading edge 6F is located higher than the trailing edge 6B relative to the horizontal plane, i.e. the rear wing 6 has a slight positive angle of incidence. The rear wing 6 is positioned so as to intersect with the above-described horizontal surface which practically includes the chord lines of the front wing 4 relative to the up and down direction. It is discovered by numerical simulation that the aircraft 2 tends to become tailheavy (i.e. with zero elevator deflection, the front part of the aircraft is lifted up stronger than the rear part) if the chord lines of the rear wing 6 are parallel to (or straight to) the chord lines of the front wing 4. Consequently, a part of or all of the chord lines of the rear wing 6 are slightly inclined relative to the horizontal direction in order to trim the aircraft 2 so that the leading edge 6F is located higher than the trailing edge 6B relative to the horizontal plane. Therefore, the rear wing 6 can provide greater lifting power than the front wing 4. The optimal angle of inclination can be determined by numerical simulation or practical flight tests.

The scope of this invention is not limited to the type and purpose of wing inclination described above. Both the front wing 4 and the rear wing 6, in whole or in part, can be inclined relative to the horizontal direction as shown in FIG. 16c if required for trimming (for example, in order to compensate a non-optimal position of the center of gravity of the aircraft), or for other purposes. FIG. 16b shows another example of the wing inclination.

(Example of the Inclination of the Chord Lines)

It is confirmed by numerical simulation that the aircraft 2 can attain increased flight stability by adjusting the angles made by the chord lines of the front wing 4 and the chord lines of the rear wing 6 along the wingspan direction and by maximizing the difference at the middle of the wings 4 and 6. It is preferable to be Y=0.95Y₀˜1.05Y₀, Y₀=−8.5*10⁻⁸X⁴+1.70*10⁻⁵X³⁻1.54*10⁻³X²+6.9*10⁻²X where X is the ratio (0˜100%) of the length from one airfoil tip to the other airfoil tip relative to the wingspan direction and Y is the angle (degree) at the point where the ratio is X.

(The Position of the Center of Gravity)

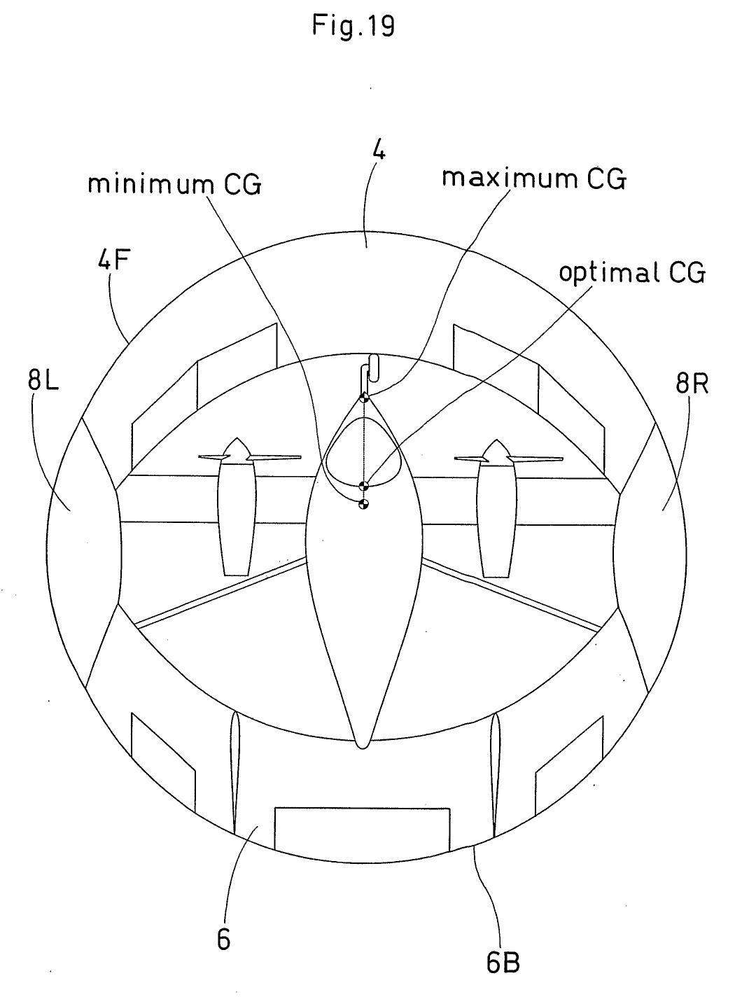

The center of gravity (CG) of the aircraft 2 is located slightly anterior to the center of the perfect circle outlined by the leading edge 4F and the tailing edge 6B (the center of the perfect circle is also the center of the top view). For the embodiment shown in FIG. 1, it is preferred that the distance from the CG to the center of the top view always lies between about 7% and 24% of the aircraft length (between the minimum CG position and the maximum CG position shown in FIG. 19) relative to the front and rear direction. These values can vary for different embodiments of this invention.

When the distance from the CG to the center of the top view is about 10% (the optimal CG in FIG. 19) of the aircraft length, the aircraft 2 stays in level flight with zero elevator trimming, provided that the chord lines of the rear wing 6 are slightly inclined as described above. With no inclination of both wings, the distance of the optimal CG position from the center of the top view is about 16% of the aircraft length. When the CG distance from the center of the top view has the minimum value of about 7% of the aircraft length, the aircraft 2 is still controllable, and level flight can be achieved by some down-trimming of an elevator 16. When the distance from the CG to the center of the top view is longer than 10% of the aircraft length (or 16% in the case of a non-inclined rear wing), the aircraft increases flight stability compared to positions closer to the center of the top view, but becomes noseheavy. However, when the maximum distance is less than about 24% of the aircraft length, level flight can still be achieved by some up-trimming of the elevator 16. In the tested aircraft, the up-trimming of the elevator 16 was 17.5 degrees or 50% of the full elevator deflection when the distance was 24% of the aircraft length. A non-optimal CG position can also be compensated by changing the wing inclination as described above, achieving basically the same effect as trimming of the elevator. Another possibility to compensate a non-optimal CG position is changing the area of one wing compared to the other wing by increasing or decreasing the length of its chord lines, so the smaller wing area will produce less lift.

(Flaps)

As shown in FIG. 3, a pair of flaps 10L and 10R is provided to the trailing edge 4B of the front wing 4 and a pair of flaps 11L and 11R is provided to the trailing edge 6B of the rear wing 6 posterior to the flaps 10L and 10R relative to the horizontal direction of the aircraft 2. Herewith, the lift coefficient of the front wing 4 and the rear wing 6 is raised for takeoff and landing, so that the aircraft 2 can take off and land over a short distance. Depending on the embodiment of this invention, the flaps 11L and 11R on the rear wing 6 can be omitted, for example, to provide space for vertical stabilizers/rudders as described in another embodiment below. The flaps 10L and 10R on the front wing 4 can be omitted as well if not required for the desired takeoff performance.

(Ailerons)

A pair of ailerons 12L and 12R is provided to the trailing edge 4B of the front wing 4 so that the inside edge of the ailerons 12L and 12R is located near the outside edge of the flaps 10L and 10R and the outside edge of the ailerons 12L and 12R is located near the airfoil tips 4E₁ and 4E₂. On the other hand, a pair of ailerons 14L and 14R is provided to the trailing edge 6B of the rear wing 6 posterior to the ailerons 12L and 12R relative to the horizontal direction of the aircraft 2 so that the inside edge of the ailerons 14L and 14R is located near the outside edge of the flaps 11L and 11R and the outside edge of the ailerons 14L and 14R is located near the airfoil tips 6E₁ and 6E₂. Depending on the control system used, the left side ailerons 12L and 14L can be controlled simultaneously or separately. In the same way, the right side ailerons 12R and 14R can be controlled simultaneously or separately. For instance, the movement of the aircraft 2 relative to the rolling direction is controlled by deflecting the right side ailerons 12R and 14R upward and simultaneously deflecting the left side ailerons 12L and 14L downward, or deflecting the right side ailerons 12R and 14R downward and simultaneously deflecting the left side ailerons 12L and 14L upward.

(Elevator)

The elevator 16 to control the aircraft 2 about the pitch axis is provided between the flaps 11L and 11R at the trailing edge 6B of the middle of rear wing 6. In addition, by adjusting the trim of the elevator 16, level flight can be achieved even if the position of the center of gravity is not optimal and this undesired CG position is not fully compensated by the inclination of the rear wing as described above.

(Fuel Tanks, Wheel Wells, Vertical Fins, Rudders)

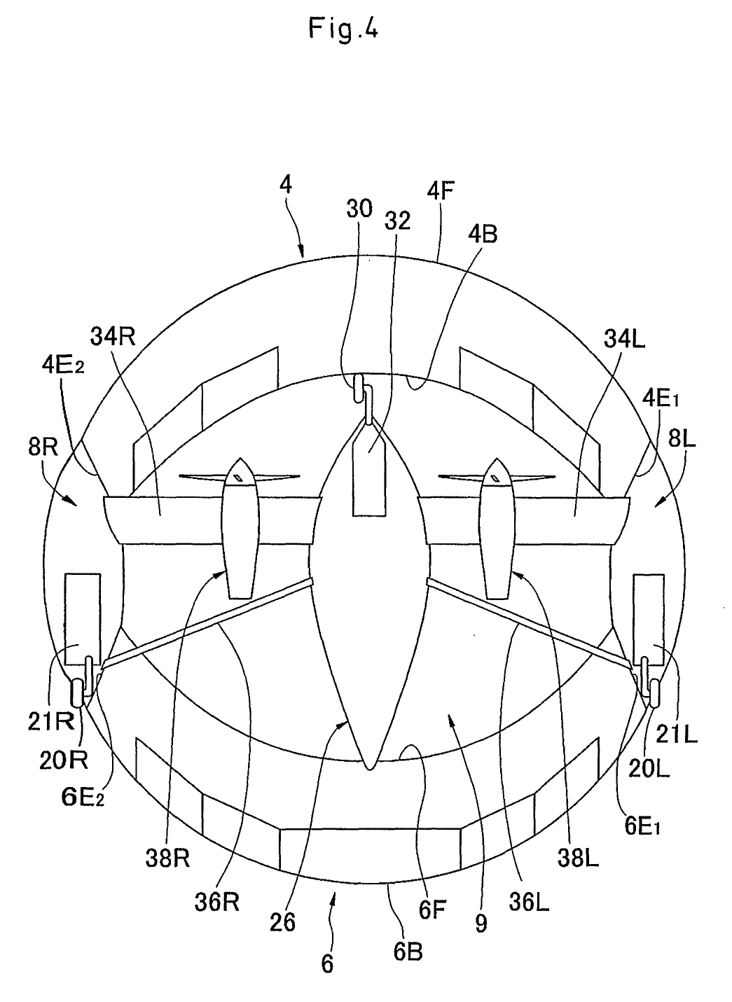

As shown in FIG. 4, fuel tanks (not shown in the figures) and wheel wells 21L and 21R for rear wheels 20L and 20R are provided inside of each of the wing boxes 8L and 8R. Vertical fins 22L and 22R, as shown in FIG. 1, are provided on the upper surface of each of the wing boxes 8L and 8R. The wheels can also be attached to other parts of the aircraft where technically possible, or can be replaced by skids (if the aircraft only takes off vertically as described below), or omitted if not required, and their number can be changed if required. Rudders 24L and 24R to control the aircraft 2 about the Yaw axis are provided to the trailing edge of the vertical fins 22L and 22R. These fins also have a stabilizing effect in flight. However, they are not essentially required for flying, so they can be omitted, for example, to achieve a reduction of radar reflectivity (stealth capability). The aircraft can also be controlled with the ailerons and elevator alone.

(A Body)

A body 26 having an aerodynamic shape is arranged around the center of the center opening 9 which is formed by the trailing edge 4B of the front wing 4, the leading edge 6F of the rear wing 6, and the internal surfaces of the wing boxes 8L and 8R. Cameras, not shown in the figures, are loaded in the body 26 and take images through a forehead window 28. The body 26, as shown in FIG. 4, also has a wheel well 32 for a front wheel 30. The body 26 further has a radio transmitting and receiving apparatus with an antenna, not shown in the figures, to receive messages or orders from outside and to transmit images and a control system to send signals by wireless or wired into a servo mechanism which controls each movable part of the wings (e.g. flap, aileron, elevator, rudder) depending on the received orders. The body 26 can also contain a fuel tank (in addition to or instead of the tanks in the wing boxes) and other equipment required for the specific purpose of the aircraft. The body 26 is interconnected with the wing boxes 8L and 8R (see FIG. 4) near the airfoil tips 4E₁ and 4E₂ of the front wing 4 on contact with wide struts (pylons) 34L and 34R jutting from both sides of the body 26 at the front of the center of the body 26. The body 26 is also interconnected with the wing boxes 8L and 8R near the airfoil tips 6E₁ and 6E₂ of the rear wing 6 on contact with narrow struts (torque bars) 36L and 36R jutting from both sides of the center of the body 26 and interconnected with the middle part of the leading edge 6F of the rear wing 6 on contact with the rear part of the body 26. The body 26 can be supported only by the pylons 34L and 34R and the struts 36L and 36R. If not required for mechanical stability, the struts 26L and 36R can be omitted.

The shape of the body 26 can be changed to any aerodynamic shape (as long as it leaves enough space for the engines and for a sufficient airflow onto the rear wing) and can be attached to any of the two wings (or none of them if supported sufficiently by the pylons). To improve the connection to the rear wing 6 aerodynamically compared to the connection shown in FIG. 1, a structural flange can be added to provide a smoother transition between the body 26 and the rear wing 6. An additional connection of the body 26 shown in FIG. 1 to the front wing 4 can be realized, for example, by a thin tube connecting the nose of the body 26 to the trailing edge of the front wing 4.

(Pylons)

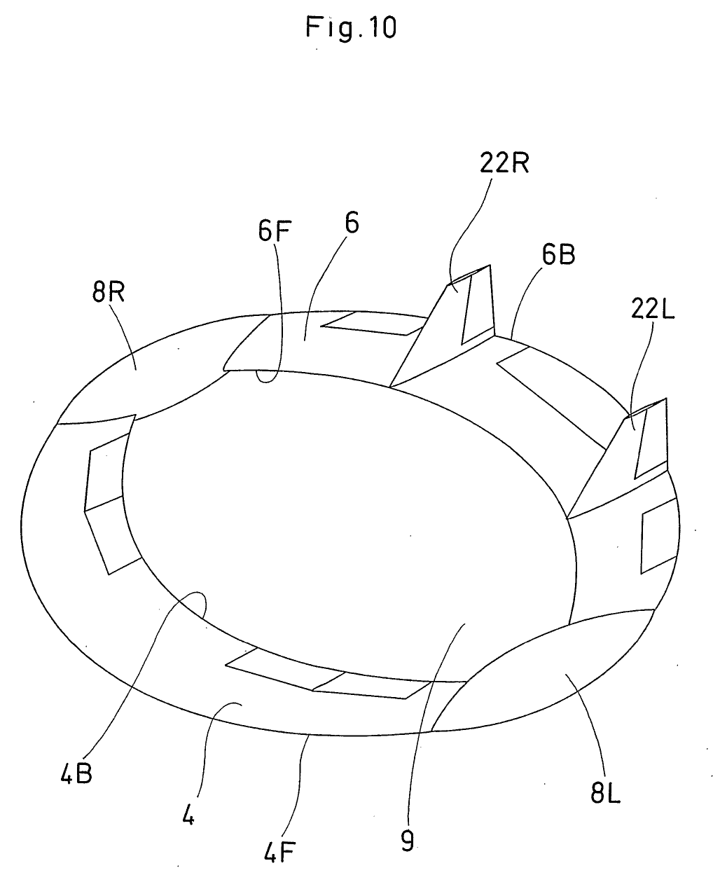

The pylons 34L and 34R are located approximately at the vertical center of the body 26. When the body 26 is made from two identical halves, the pylons 34 L and 34R would be right between the halves, so no holes must be made in the cabin hall for the pylons 34L and 34R, only indentations need to be made where the halves meet. By providing the pylons 34L and 34R between fuselage and engines, the aircraft 2 can gain some mechanical strength and optional payload space (e.g. for sensors, etc.), while their main purpose is carrying the engines 38L and 38R (see below). For an embodiment without engines (glider plane), the pylons can be omitted if not required otherwise, as shown in FIG. 10. It is preferred aerodynamically that the shape of the pylons 34L and 34R is made so as not to disturb the airflow between the wings 4 and 6.

(Position of the Elevator)

The elevator 16 of the rear wing 6 is arranged within the area surrounded by the extended lines of major axes (the propellers' axes of rotation) of the engines 38L and 38R so as to prevent the propeller slipstream from hitting the elevator 16 and generating a vortex, causing a drop in performance of the aircraft 2. In this embodiment, as shown in FIG. 3, the flaps 11L and 11R of the rear wing 6 are arranged posterior to the engines 38L and 38R relative to the horizontal direction so that the propeller slipstream hits the flaps 11L and 11R which change the direction downward, and therefore lifting power can be increased.

(Engines)

Engines 38L and 38R, as propeller engines, having an aerodynamic shape with propellers 37L and 37R in front are provided to each of the pylons 34L and 34R. The rotation direction of the propeller 37L is opposite to that of the propeller 37R, so the undesired torque effects of the two engines compensate each other. Fuel is provided to the engines 38L and 38R from the fuel tanks in the wing boxes 8L and 8R or in the body 26 through the fuel pipes (not shown in figures) in the pylons 34L and 34R according to instructions from the control system in order to rotate the propellers 37L and 37R. Electric engines can be used alternatively instead of piston engines.

Optionally, the engines 38L and 38R can be controlled independently, so a yaw momentum can be achieved by turning one propeller faster than the other. This can be used to assist or replace the effect of the rudders.

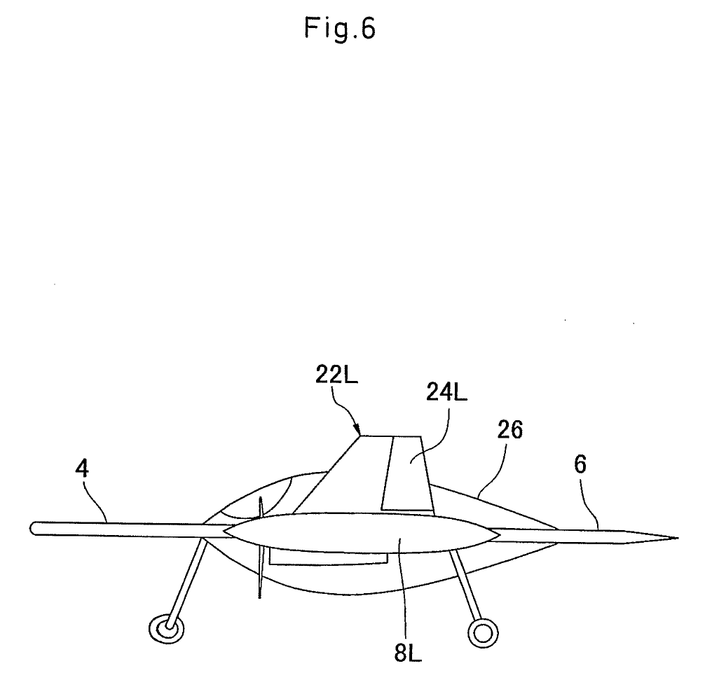

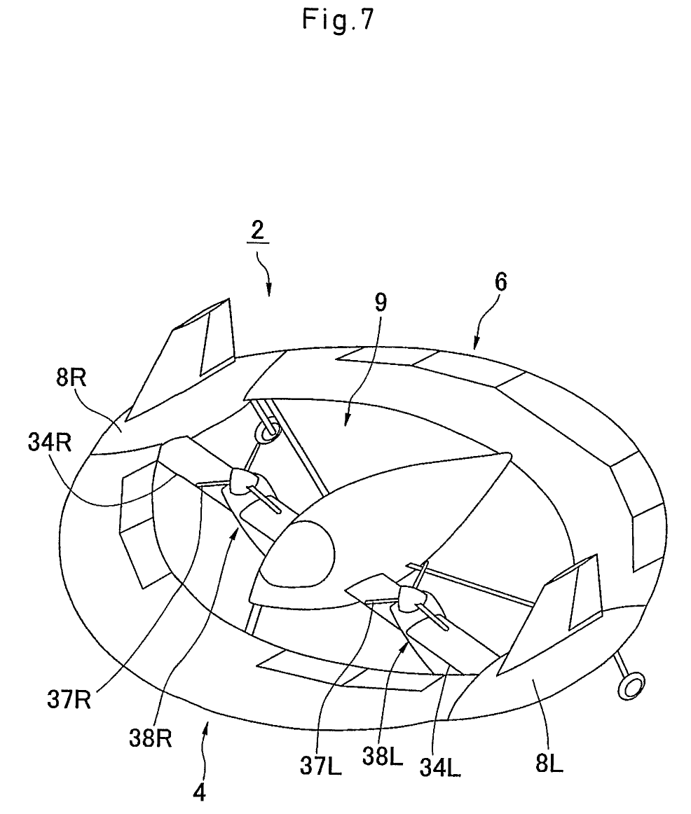

The engines 38L and 38R are rotatably supported by the pylons 34L and 34R. They can be rotated, according to the instructions from the control system, about 90 degrees between the horizontal position (the first position, used for normal forward flight), where the rotation axes of the propellers 37L and 37R are in parallel to the horizontal direction as shown in FIG. 1, and the vertical position (the second position) that the rotation axes of the propellers 37L and 37R are perpendicular to the horizontal direction. FIG. 7 shows a position in between the two extremes. In the side view shown in FIG. 6 (seen from the left side of the aircraft), the engines 38L and 38R would rotate from the vertical to the vertical position in the clockwise direction. The rotation can be achieved either by a suitable engine mounting on the fixed pylons, or by rotating the entire pylons around their long axis together with the engines.

For a vertical takeoff, it is essential that the centers of the propellers (when in the vertical position) are located so that a line connecting both propeller tips would cross the center of gravity of the aircraft. For this reason, it is preferable to mount the fuel tanks in a position where their own centers of gravity are in line with the CG of the aircraft as well, so the reduction of fuel during flight does not shift the CG of the entire aircraft.

(Cameras)

Cameras (not shown in figures) can be mounted anywhere on the aircraft 2, for example, on the wings 4 and 6, the wing boxes 8L and 8R, the body 26, the pylons 34L and 34R and so on. It is preferred that the cameras are a type of sensor in both function and design. The cameras are used not only to produce image data but also to gather data in other frequency ranges as sensors. Sensors such as hyper-spectral, radar and sonar, both active and passive, can be used to collect data from the environment. Thus, the aircraft 2 can be used as a sensor platform where the cameras (sensors) are mounted with true 360 degree sensing capability either in longitude or latitude (including off-axis sensing) or combination of the two. Electric lights directed towards the ground can be installed as well in order to improve vision at night and to facilitate search and rescue operations.

(Takeoff)

The aircraft 2 with the above-mentioned structures can take off in the vertical direction by setting the engines 38L and 38R to the vertical position as shown in FIG. 7 and making the propellers 37L and 37R rotate. If needed, the flaps 10L, 10R, 11L and 11R can be moved downward. After takeoff, the engines 38L and 38R are put back to the horizontal position, which gradually turns the vertical motion into a horizontal motion, so the aircraft enters conventional (aerodynamic) flight. As occasion demands, the aircraft 2 can hover by putting back the engines 38L and 38R into the vertical position again. It is preferable though to maintain at least a very slow forward motion, so the ailerons and elevator remain effective and the aircraft can be controlled as desired. This can be achieved either by setting the engines to a position which is not completely vertical (as shown in FIG. 7), or by moving the nose of the aircraft slightly down before setting the engines to completely vertical, so that in both cases the propellers still provide a slight forward thrust component. To achieve complete maneuverability even at zero speed, additional air jet vents (reaction thrusters, also called “puffers”, similar to those used on VTOL jet fighters like the Hawker Harrier) can be installed on the periphery of the aircraft, which can push or rotate the aircraft in any desired direction while hovering.

The aircraft 2 can also take off horizontally like a conventional airplane if the engines are in the horizontal position, for example if the aircraft is to carry a payload too heavy for a vertical takeoff. By setting the engines to some position between horizontal and vertical, the length of the runway required for takeoff can be significantly reduced while still achieving the improved aerodynamic stability of a horizontal takeoff. Such intermediate positions can also be used in flight to achieve almost any angle of motion between horizontal and vertical and to reduce forward speed to low values that cannot be achieved with conventional airplanes.

(Effect of the Position of the Propellers)

According to this embodiment, as the propellers 37L and 37R are arranged within the center opening 9 surrounded by the wings 4 and 6, there is no risk that the propellers 37L and 37R crash into the walls of buildings and therefore the aircraft 2 can be navigated safely even in treacherous areas such as inhabited or narrow areas and even inside buildings in some cases. Furthermore, as the engines 38L and 38R and the fuel tanks are separated, the risk that large amounts of fuel catch fire from the hot engines in the case of a crash is greatly reduced.

(Effect of the Peripheral Shape of the Center Opening)

The trailing edge 4B of the front wing 4 and the leading edge 6F of the rear wing 6 which mark off a boundary of the center opening 9 which is roughly elliptical shape with its major axis extending in the direction orthogonal to the forward direction. Therefore, the space of the center opening 9 is maximized. As a result, the opening 9 not only provides enough space for a relatively large body 26, but also for relatively large propellers 37L and 37R, which are required for high forward speeds and for vertical takeoff. This is a significant advantage compared to the aforementioned GEOBAT design.

(Effect of the Elliptical Wing Structure)

As the aircraft 2 of this embodiment having an elliptical wing structure provides a comparatively large wing area relative to the length and width of the aircraft, it possesses the advantage that it can fly and maneuver in narrow areas. Furthermore, as lifting power is distributed around the center of gravity due to the elliptical wing structure, the aircraft 2 has high stability at low speed. In addition, the aircraft 2 having the elliptical wing structure possesses another advantage which is that it rarely falls into an unrecoverable spin state. This is because lifting power is generated even if the aircraft 2 is struck by wind from the side or moves into a diagonal direction for some reason, since the curvature of the wings guarantees that at almost any angle of movement, at least a part of the leading edges of both the front and rear wing still hits the air at a 90 degree angle (as a conventional wing does in forward flight only), thus generating identical or similar lifting forces at both ends of the aircraft.

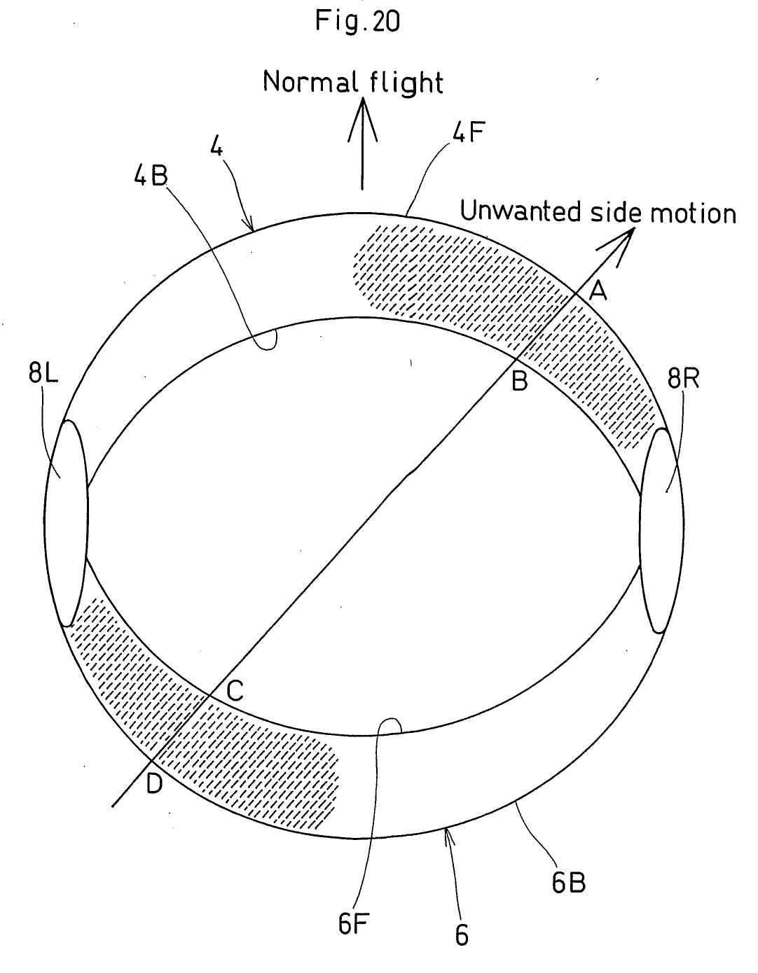

As shown FIG. 20, in the aircraft 2 of this embodiment having circular-elliptical wing structure, the wings 4 and 6 have a continuously changing angle between the wing edge and the airflow, depending on which part of the edge being looked at.

Assuming that for some reason the aircraft 2 is not moving straight ahead, but, for example, in the direction indicated by the arrow in FIG. 20, there are some parts of the wings 4 and 6 where the wing edge still has an angle of approximately 90 degrees against the airflow (i.e. as if the aircraft 2 were supposed to fly in that direction). When imagining a cross-section through the wings along the lines A-B and C-D, an almost normal airfoil profile can be seen, which means that the shaded parts of the wings 4 and 6 in FIG. 20 will produce almost normal lifting power when the aircraft is moving in the indicated direction.

As long as there is some forward component in the movement vector, the wings 4 and 6 having elliptical wing structure will still produce some lifting power regardless of the flight angle. In the aircraft with the elliptical wing structure, there is a smooth transition between the behavior at normal flight (maximum lift) and sideways flight (minimum lift), whereas a conventional aircraft will at some point lose lifting power quite suddenly when changing course from straight ahead into sideways motion. This is the main reason for the fact that the aircraft 2 having an elliptical wing structure can remain quite stable in the air and can recover from any undesired flight attitude merely by using the elevator and ailerons.

(Another Version of the Angle of the Chord Lines)

While certain preferred embodiments of the invention have been described, it is to be distinctly understood that the invention is not limited thereto but may be otherwise variously embodied within the scope of the following claims. For example, although the chord lines of the front wing 4 are set up within the horizontal surface in the above embodiment, the chord lines of the front wing 4 may be set up so that the leading edge 4F is located slightly below the trailing edge 4B. In this case, it is possible to ensure stability of the aircraft 2 by setting up the chord lines of the rear wing 6 so that the leading edge 6F is located slightly above the trailing edge 4B. Any other combination of chord inclinations is possible as well as described before. Some examples are shown in FIG. 16.

### Other Embodiments

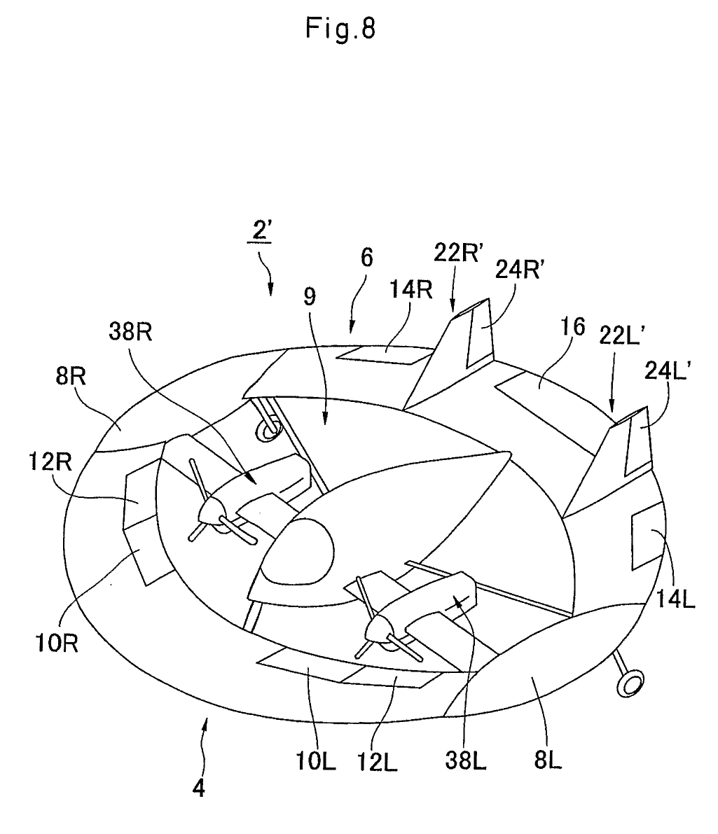

Moreover, although the vertical fins 22L and 22R are provided on the upper surface of the wing boxes 8L and 8R in the above embodiment, the vertical fins 22L′ and 22R′ may be provided on the upper surface of the rear wing 6 as shown in an aircraft 2′ in FIG. 8. In this case, compared to the above embodiment, the distance between the vertical fins 22L′ and 22R′ and consequently the distance between rudders 24L′ and 24R′ is short, so large yaw angles can be obtained with small rudder angles, and as a result the mobility of the aircraft can be increased. In addition, in this version the rudder 24L′ and 24R′ are located behind the engines 38L and 38R so the propeller slipstream flows directly onto the rudders 24L′ and 24R′ and consequently the performance of the rudders is improved.

This embodiment requires the rear flaps 11L and 11R to be omitted or to be reduced in size.

The ailerons 14L and 14R may be provided at the rear of the engines 38L and 38R relative to the horizontal direction so that the propeller slipstream flows into the ailerons 14L and 14R and consequently the performance of the ailerons is improved. This variant is possible if the flaps 11L and 11R are omitted or moved to the outside of the ailerons 14L and 14R.

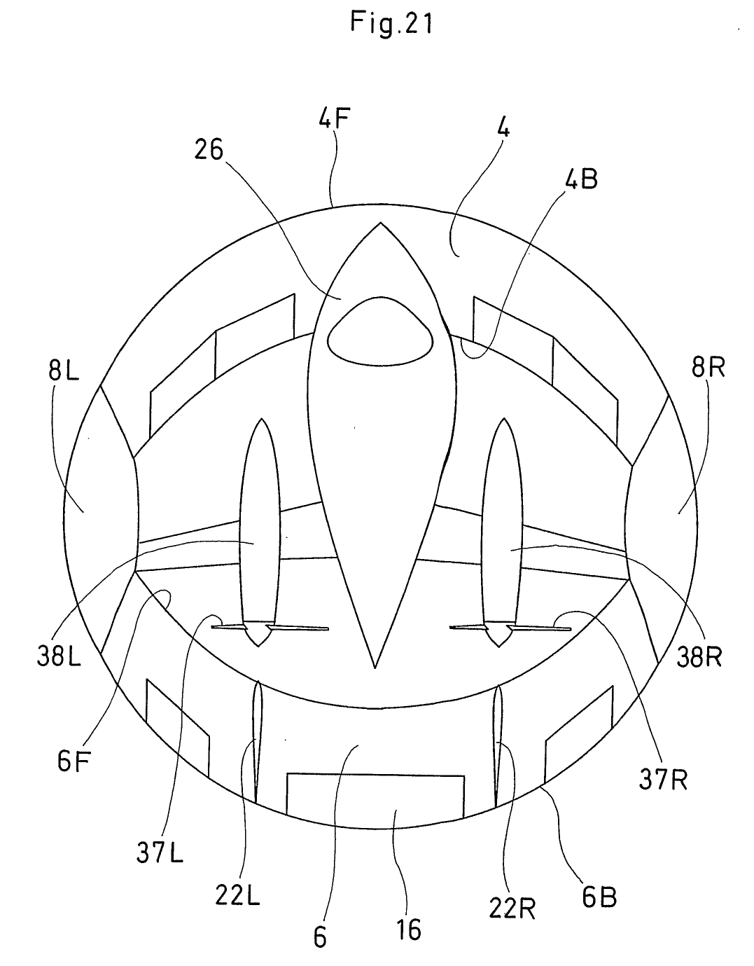

Although, in the above embodiment, the propellers 34L and 34R are provided at the front of the engines 38L and 38R, propulsive propellers may be provided at the rear of the engines 38L and 38R, as shown in FIG. 21. In this case, it is preferable to move the body 26 forward compared to the above embodiment and attach it to the front wing as shown in FIG. 21 so that the space for the propulsive propellers in the center opening 9 is enlarged.

Furthermore, in the case of a manned aircraft, the body 26 may be used as a cabin.

In addition, in the case of unmanned aircraft like the one described in the above embodiment, components such as the body 26 may be omitted and, instead, dedicated engines for vertical take off and landing (VTOL) aircrafts can be installed in the center opening, e.g. a large rotor similar to a helicopter. In this case, the two regular engines can remain fixed in the horizontal position. In order to compensate the torque from the VTOL rotor and to avoid spinning of the entire aircraft, either a second rotor of the same size rotating in the opposite direction can be mounted on the same axis slightly above the first rotor, or an additional tail rotor (as on a conventional helicopter) can be mounted somewhere on the rear part of the aircraft, or the two horizontal engines can be controlled independently, so the rotor torque can be compensated by rotating one engine faster than the other.

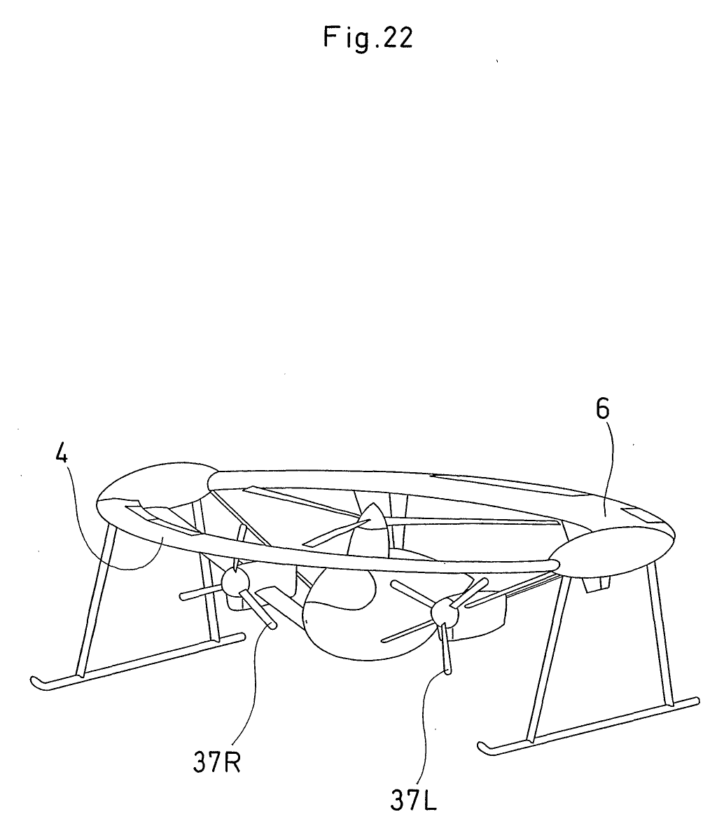

If the body 26 is required for equipment or as a cabin for a manned aircraft, the VTOL rotor variant is still possible if the body 26 and the pylons carrying the horizontal engines are lowered below the plane of the circular wing structure, as shown in FIG. 22.

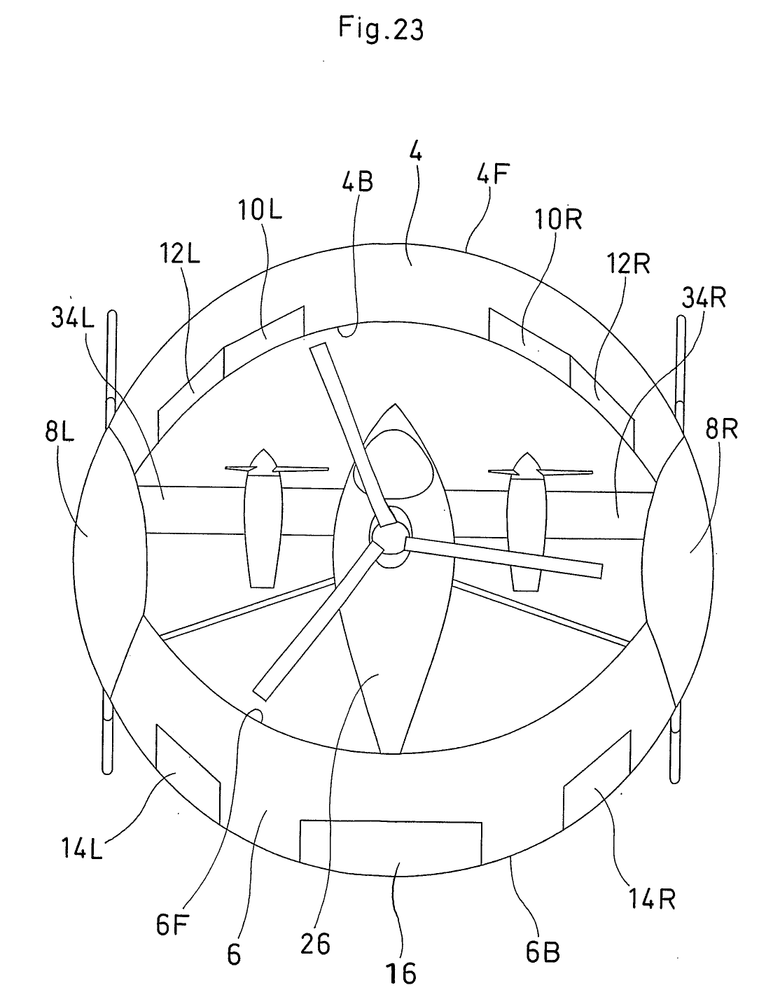

This embodiment also shows an application of differently sized wings, which can bee seen clearly in the top view (FIG. 23): The front wing area is smaller than the rear wing area, which allows the CG to be moved closer to the center of the aircraft compared to identical wing areas, which is important in this case, because the axis of the VTOL rotor must be exactly above the CG, and the rotor that fits between the wings can be made larger if the axis is closer to the CG. In addition, the smaller size of the front wing increases the space available for the rotor even more.

This embodiment shown in FIG. 22 also shows that skids can be used instead of a wheeled landing gear. In addition, the vertical fins and rudders are installed below the rear wing in this case in order to be located in the airflow from the horizontal propellers.

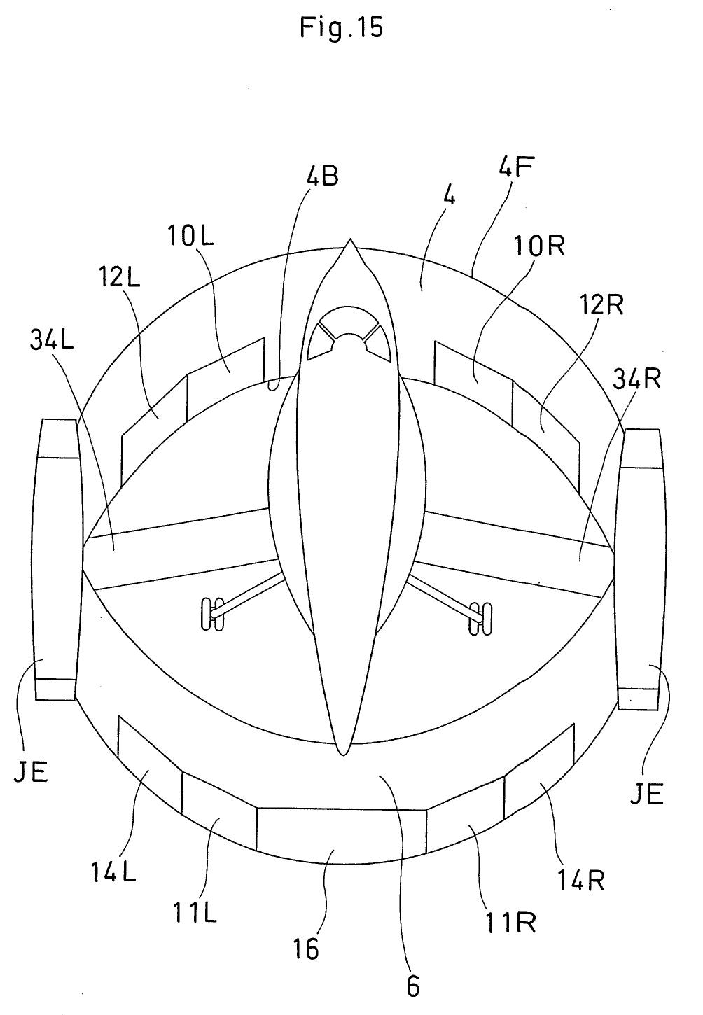

Further, although piston engines 38L and 38R providing acceleration by generating a strong stream of air from the propellers 37L and 37R are used in the above embodiment, in exchange for this type of engines, turbojet engines or ducted fan-type piston engines can be provided on the wing boxes 8L and 8R or replacing the wing boxes completely. Aircraft with these types of engines can also fly and maneuver safely in treacherous areas like inhabitable areas in the same way as the above embodiment. When turbojet engines or ducted fan-type engines are provided on the wing boxes 8L and 8R, the engines for VTOL aircraft may be provided at the center opening 9, or can be omitted if vertical takeoff is not required. FIG. 15 shows an embodiment version with jet engines (JE) instead of the wing boxes.

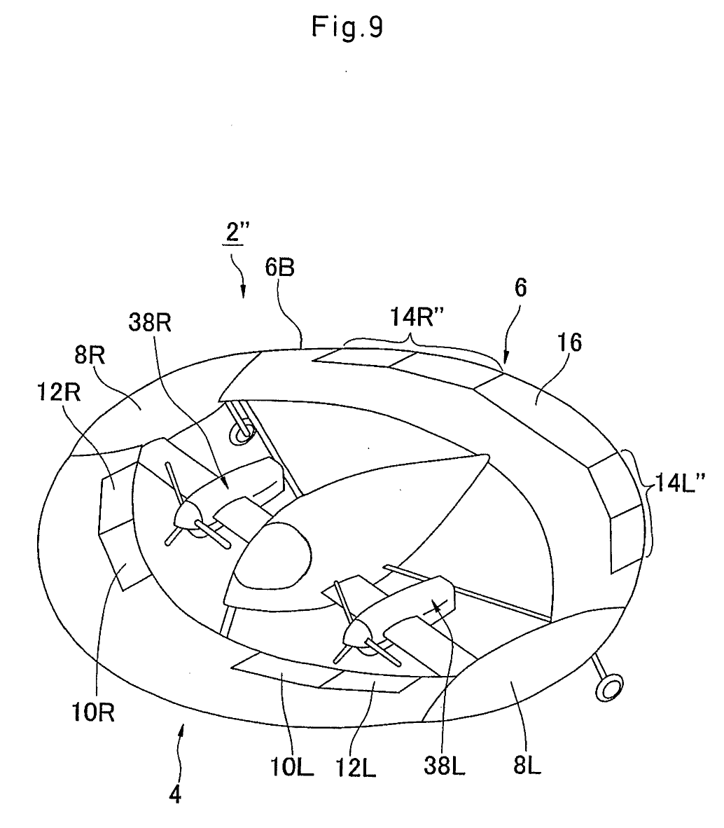

Furthermore, as in the aircraft 2″ shown in FIG. 9, a pair of drag rudders (also called split ailerons) can be installed on the rear wing next to the normal ailerons instead of the flaps 11L and 11R. Either the outer or the inner pair of control surfaces labeled 14L″ and 14R″ can be the drag rudders, the other pair are the normal ailerons (the effect of the drag rudders is higher when they are placed in the outer position). These drag rudders can be used for yaw control similar to normal rudders, but by inducing increased drag on one side of the aircraft (the side where the drag rudder is deployed). In this case, the vertical fins with the normal rudders can be omitted. Alternatively, the yaw direction can be controlled by making a difference in thrust between the engines 38L and 38R. (For example, the aircraft turns toward the right when the thrust of the right engine 38R is reduced.) In any case, by omitting the vertical fins, the stealth characteristics (radar invisibility) of the aircraft are improved.

The aircraft 2 may include turbo jet engines or ducted fan-type propeller engines arranged on the first and second wing boxes respectively or completely replacing the wing boxes. As shown in FIG. 14, the peripheral shape of the center opening 9 may be symmetrically formed by the trailing edge 4B of the front wing 4, the leading edge 6F of the rear wing 6, the internal surface of the jet engine (JE) or the internal surface of the second jet engine (JE), the wing edges being straight lines.

Since the version having jet engines does not necessarily require pylons between the fuselage and the engines, an even cleaner airflow between the front wing and the rear wing can be achieved than with the propeller engine versions.

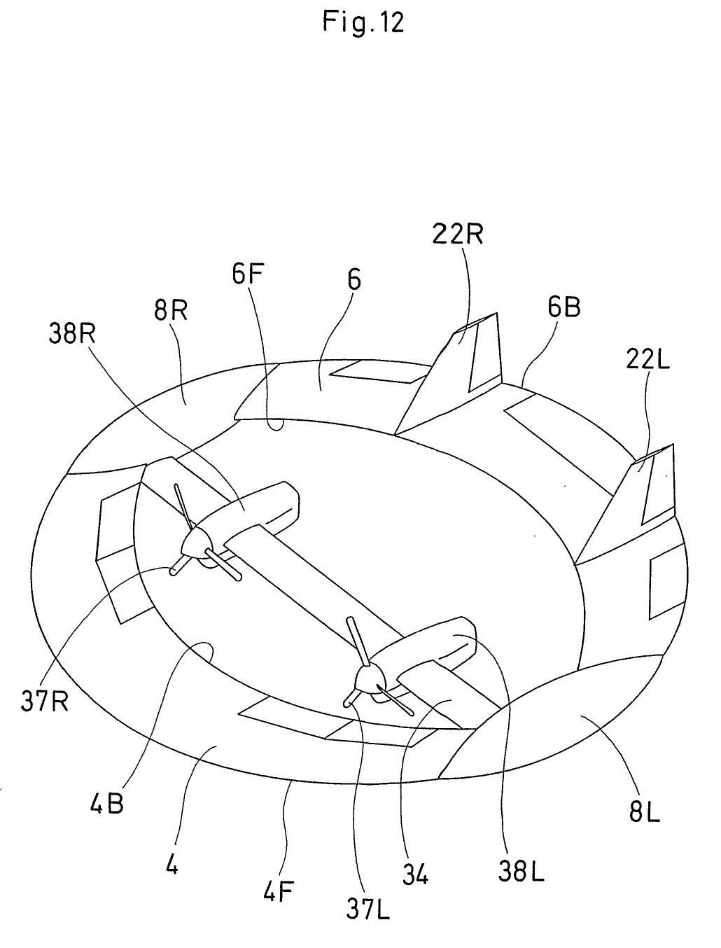

The embodiment shown in FIG. 12 does not have the body 26, which is possible if all required equipment can be mounted on other parts of the aircraft. This version reduces the air resistance and weight compared to the versions having the body 26.

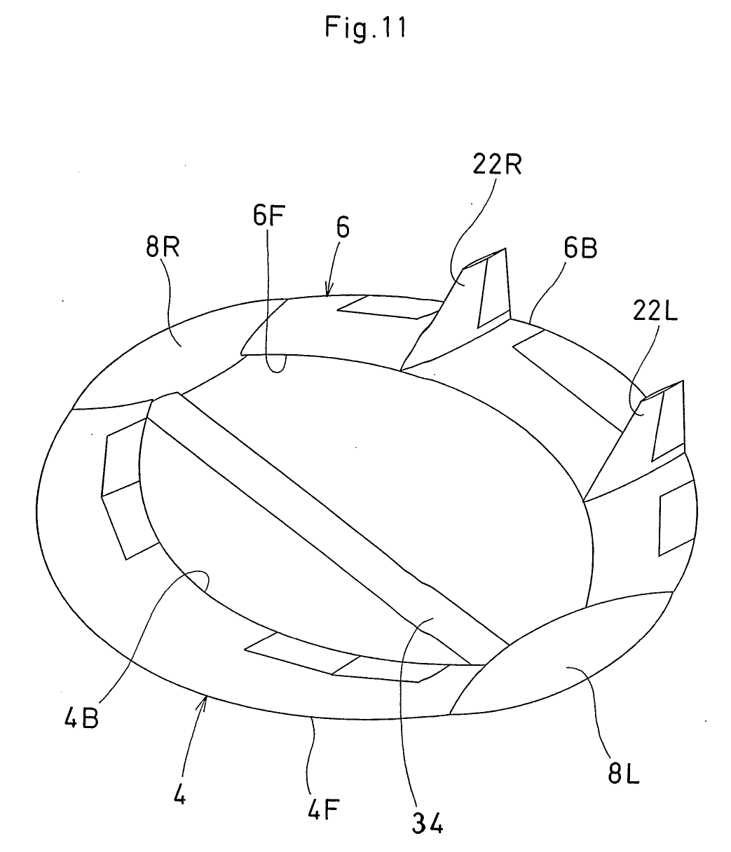

The embodiment shown in FIG. 11 is a glider plane without engines, which can, for example, be deployed from manned aircraft for time-limited surveillance missions. The pylon 34 shown in FIG. 11 can be omitted if not required for mounting equipment on it, as shown in FIG. 10.

1. An aircraft comprising:
a boomerang-shaped front wing curving gibbously to a front of the aircraft, which has a leading edge, a trailing edge and a first and second airfoil tips;
a boomerang-shaped rear wing curving gibbously to a back of the aircraft, which has a leading edge, a trailing edge and a third and forth airfoil tips;
a first wing box connecting the first airfoil tip of the front wing and the third airfoil tip of the rear wing; and
a second wing box connecting the second airfoil tip of the front wing and the fourth airfoil tip of the rear wing,
wherein the trailing edge of the front wing, the leading edge of the rear wing, an internal surface of the first wing box and an internal surface of the second wing box form a center opening.

2. The aircraft according to claim 1 wherein the center opening has a substantially elliptical shape.

3. The aircraft according to claim 1 wherein the center opening has a polygonal shape.

4. The aircraft according to claim 1 wherein the center opening has a substantially rhombus shape.

5. The aircraft according to claim 1 wherein the center opening has a shape made of a combination of any one of elliptical, polygonal, and rhombus shape.

6. The aircraft according to claim 1 further comprising propeller engines in the center opening.

7. The aircraft according to claim 1 further comprising any one of jet engines and ducted fan-type engines.

8. The aircraft according to claim 6 further comprising a possibility to control the speed of each engine independently.

9. The aircraft according to claim 1 wherein at least a chord line of the front wing is slightly inclined relative to a horizontal surface so that the leading edge of the front wing is located one of higher and lower than the trailing edge relative to the horizontal surface.

10. The aircraft according to claim 1 wherein at least a chord line of the rear wing is slightly inclined relative to a horizontal surface so that the leading edge of the rear wing is located one of higher and lower than the trailing edge relative to the horizontal surface.

11. The aircraft according to claim 1 wherein angles made by the chord lines of the front wing and the chord lines of the rear wing differ from one chord line to another along a wingspan direction.

12. The aircraft according to claim 11 wherein the angle of inclination of the rear wing satisfies:
Y=0.95Y₀˜1.05Y₀ and
Y₀=−8.5*10⁻⁸X⁴+1.70*10⁻⁵X³−1.54*10⁻³X²+6.9*10⁻²X,
where X is a ratio (%) of a length from an airfoil tip to another airfoil tip of the rear wing relative the wingspan direction and Y is an angle (degree) at a point where the ratio is X.

13. The aircraft according to claim 6
wherein the engines include a first engine and a second engine which are supported by a first pylon and a second pylon jutting from the first and the second wing boxes respectively,
wherein fuel tanks are provided inside of each of the first and the second wing boxes, and
wherein fuel is provided to the first, and second engines from the fuel tanks in the wing boxes through fuel pipes provided in the first and second pylons.

14. The aircraft according to claim 13 wherein the first and the second engines are rotatably supported by the first and the second pylons to rotate about 90 degrees between a first position wherein rotation axes of propellers are approximately in parallel to a horizontal surface and a second position wherein the rotation axes of the propellers are approximately perpendicular to the horizontal surface.

15. The aircraft according to claim 14 further comprising an elevator arranged within an area surrounded by extended lines of major axes, at the propellers' axes of rotation, of the engines on the trailing edge of the rear wing.

16. The aircraft according to claim 6 further comprising two pairs of front ailerons on the front wing and two pail's of rear ailerons, both the front and the rear ailerons are controlled one of synchronously and independently.

17. The aircraft according to claim 6 further comprising vertical fins at one of directly behind the engines relative to a horizontal direction on the rear wing, and on the top surface of the first and second wing boxes.

18. The aircraft according to claim 17 wherein the vertical fins include rudders.

19. The aircraft according to claim 6 further comprising drag rudders on the rear wing.

20. The aircraft according to claim 1 wherein a center of gravity of the aircraft is located anterior to the center of the top view of the aircraft.

21. The aircraft according to claim 1 wherein the boomerang-shaped front wing has a different wing area from the boomerang-shaped rear wing.

22. The aircraft according to claim 1 wherein at least one several vertical takeoff and landing (VTOL) rotor is provided in the center opening.

23. The aircraft according to claim 1 wherein a central body is provided in the center opening, attached to one of the front and the rear wings and the pylons only and is located one of within and below a horizontal plane denned by the front and the rear boomerang-shaped wings.

24. The aircraft according to claim 1 wherein jet vents are provided on a periphery of the aircraft to control the aircraft while hovering.
